(19) United States
(12) Patent Application Publication
(10) Pub. No.: US 2004/0265753 A1
(43) Pub. Date: Dec. 30, 2004

(54) Manufacturing method of cover layer of optical information storage media

(76) Inventors: Wen-Yih Liao, Taichung City (TW); Huei-Wen Yang, Taoyuan Hsien (TW); Ching-Yu Hsieh, Hsinchu (TW); Chuen-Fuw Yan, Kaohsiung (TW); Tzuan-Ren Jeng, Hsinchu (TW)

Correspondence Address: J.C. Patents, Inc., Suite 250, 4 Venture, Irvine, CA, 92618, US

(21) Appl. No.: 10/731,530

(22) Filed: Dec. 8, 2003

(30) Foreign Application Priority Data
Jun. 24, 2003 (TW) 92117085

(51) Int. Cl. G11B 7/24

(52) U.S. Cl. 430/321; 427/162

(57) ABSTRACT

A manufacturing method of cover layer of optical information storage media is disclosed. A plate and a substrate having a signal structure or recording layer are provided, a polymer resin is applied on the substrate. The plate is made to come in contact with the radiation-setting resin and then the radiation-setting resin is compressed against the substrate. The resulting structure is placed on a rotatable table and the rotatable is rotated. A radiation-setting resin layer with a uniform thickness is formed. The radiation-setting resin layer is illuminated by a UV light to harden the radiation-setting resin layer. Next, the plate is separed from the radiation-setting resin layer while the radiation-setting resin layer remain adhered to the substrate. The hardened radiation-setting resin layer serves as a cover layer.

### CROSS-REFERENCE TO RELATED APPLICATION

This application claims the priority benefit of Taiwan application serial no. 92117085, filed on Jun. 24, 2003.

### BACKGROUND OF THE INVENTION

1. Field of the Invention

The present invention generally relates to an optical information storage media. More particularly, the present invention relates to a manufacturing method of a cover layer of optical information storage media.

2. Description of the Related Art

A digital versatile disc (“DVD”) has become the main stream of an optical information storage media due to advantages of high storage density, small volume, long storage period, low cost, high compatibility and low failure rate. Therefore a lot of information containing a large number of texts, sounds and images, and the capability of conventional DVD is not suitable for the video and audio requirement of next generation. Consequently, a lot of specifications of high capacity optical storage media of next generation, for example, a high density digital versatile disc (“HD-DVD”) are set forth by some famous optical information storage media manufacturing companies. In the trend of next generation optical storage media, the wavelength of laser beam is shifted to a range of about 400 nm to about 450 nm of a gallium nitride (“GaN”) laser, and the numerical aperture (“NA”) of an optical pick-up head is enhanced to achieve a high capability up to 15 GB of single-side and single-layer of a disc, in order to fit the requirement of high quality audio and video specifications of next generation, for example, a high density television/3 dimensional video (“HDTV/3D-video”). Moreover, a lot of related specifications of storage media and research reports are published in succession.

Because the size of a focusing spot of an optical pick-up head is proportional to resolving power, i.e., proportional to λ/NA, wherein λ is a wavelength of the laser used in the optical pick-up head and NA is a numerical aperture of the object lens. When the NA value of the object lens is enhanced and the wavelength λ of the optical pick-up head is shortened, the size of the focusing spot is minimized. But the spherical aberration due to the variation of the disc thickness and the tilt of the disc is corresponding with (λ/NA)³ and (λ/NA)⁴ respectively. Therefore the allowed tilt of the disc must be particularly limited. Consequentially, it is must to have a cover layer on a disc, in order to increase the allowed tilt of the disc and the focusing length of a laser of a high NA value.

After the disclosure of a specification of optical information storage media for next generation, using an optical pick-up head with two lens combined to have a NA of 0.85 and a cover layer of 100 um thickness, is published in 1997 by Sony company, a lot of related research reports are published by some famous optical storage media manufacturing companies in succession. A specification of a laser pick-up head having a NA of 0.85 has become a trend of development of a optical storage media for next generation.

FIG. 1 is a sectional view illustrating the structure of a reading operation of a disc of a digital video recording system (“DVR system”). First of all, high density data is duplicated on a substrate 100 having a diameter 120 mm and a thickness 1.1 mm by a general injection molding process, and a metal material including, but not limited to, aluminum plated on the substrate 100 by a sputtering method is provided for a reflective layer 102. Therefore an extra-thin substrate, i.e., a cover layer 104 of FIG. 1 with a thickness of 100 μm is formed on the reflective layer 102. Thus the total thickness of the disc obtained in the process above is about 1.2 mm. When the disc is read, a laser beam emitted from the laser pick-up head 106 has to pass through the cover layer 104 of a thickness 100 μm to reach the recording layer.

Because the NA of a laser pick-up head is enhanced up to 0.85, and the allowed tilt of a disc is limited by the length of the depth of field. Therefore, if the thickness of a cover layer is reduced to a specification of an extra-thin thickness about 100 μm, an optical aberration, especially a coma aberration is easily produced by a small tilt. Another, when the variation of the thickness of a cover layer is large enough, a spherical aberration is produced due to the destruction of the focusing spot.

Numerous patents, including U.S. Pat. No. 4,845,000, U.S. Pat. No. 5,048,745, U.S. Pat. No. 5,059,473, U.S. Pat. No. 5,078,947, U.S. Pat. No. 5,126,996, U.S. Pat. No. 5,468,324, U.S. Pat. No. 5,688,447, U.S. Pat. No. 5,708,652, U.S. Pat. No. 5,820,794, U.S. Pat. No. 5,874,132, U.S. Pat. No. 6,066,218, U.S. Pat. No. 6,071,671 and U.S. Pat. No. 6,309,496, disclose a variety of methods for manufacturing recording layer of a disc. However, these patents are only limited to describe, teach or suggest the duplication of the signals of recording layer, but however do not describe the applicability of a high NA GaN laser pick-up head system for a micrometer substrate of a thickness about 0.1 mm.

In the technical literature published until now, there are two methods of manufacturing a cover layer, in which, one is a spin coating method using a radiation-setting resin, the other is a thin substrate adhesion method using a Polycarbonate (“PC”) thin substrate.

The process of manufacturing a cover layer using a spin coating method is similar to a conventional process of manufacturing a cover layer on a disc. These processes relate to form a cover layer by coating a thick layer of radiation-setting resin on a substrate and hardening the radiation-setting resin layer by an ultraviolet (“UV”) light. However, the conventional coating method will produce a high variation of the thickness of the radiation-setting resin layer on the edge of a disc when the thickness of the layer is in a range of about 90 μm to about 110 μm. Moreover, because there is a hole in the center of the disc, the conventional spin coating method can not start from the center of the disc, therefore the cover layer formed by the method will produce thicker layer near the edge and thinner layer near the center of the disc. Thus the variation of the thickness of the cover layer is large by using the, conventional spin coating method.

The other method is a thin substrate adhesion method comprising forming a cover layer by providing an extra-thin PC substrate of 0.1 mm thickness using an injection molding machine, and then adhering the PC substrate to a substrate of a disc of a thickness about 1.1 mm by using a radiation-setting resin adhesion method. Because the thickness of the thin PC substrate of the process is only 0.1 mm, the thickness of the thin substrate is a technical limitation to a conventional injection molding machine.

### SUMMARY OF THE INVENTION

Accordingly, the purpose of the present invention is to provide a manufacturing method of a cover layer of an optical information storage media, which method is applicable for manufacturing a cover layer of a laser reading operation surface of a high density digital multi-function disc.

It is another object of the present invention to provide a manufacturing method of a cover layer of an optical information storage media, which method has a capability of manufacturing a cover layer having a thickness of about 0.1 mm with an excellent thickness uniformity.

It is another object of the present invention to provide a manufacturing method of a cover layer of an optical information storage media, which method is simple and can be automatically operated for mass production and thus the yield and through-put can be substantially increased.

In order to achieve the above objects and other advantages of the present invention, a manufacturing method of a cover layer of an optical information storage media is provided. The method comprises providing a plate having a plain surface with a digital information structure or recording layer(s). Next, a reflective layer is formed on the substrate, a radiation-setting resin material is on the reflective layer. The substrate and the plate are compressed with the radiation-setting resin in between, and the resulting structure is rotated in order to control the thickness of the radiation-setting resin layer. Next, the radiation-setting resin layer is hardened by illuminating the radiation-setting resin layer with an UV light, and then the plate is separated from the hardened radiation-setting layer. The hardened radiation-setting resin layer remains adhered to the substrate as a cover layer.

According to a preferred embodiment of the invention, the substrate having a digital information structure or recording layer(s) is provided for manufacturing of a high density blue laser optical information storage media, in which the substrate includes, but not limited to, a disc comprising a read-only structure, a disc comprising a write-once structure or a disc comprising a re-writable structure. The high density blue laser optical information storage media is related to an optical information storage media, which media is suitable for recording and replaying operations for a GaN laser or a UV laser disc system using a high NA value larger than 0.5 of an object lens. The wavelength used by the GaN laser or UV laser disc system is less than 460 nm.

Moreover, the material of the plate has a poor adhesion ability, or has no adhesion to a general organic resin material. Consequently, the organic resin material has a poor adhesion to the plate, and has a better adhesion to the substrate. Therefore, after the organic resin material is hardened, and the plate is easy to separate from the organic resin material due to its poor adhesion property.

Furthermore, a poorly-adhesive metal layer can be formed on the plate before the plate is adhered to the substrate, in order to separate the plate from the organic resin more easily. As the poorly-adhesive metal layer is still covered on the plate after the plate is separated from the organic resin material, therefore the plate and the poorly-adhesive metal layer can be reused.

Furthermore, a poorly-adhesive polymer layer can be formed on the plate before the plate is adhered to the substrate, in order to separate the plate from the organic resin more easily.

Because the method of using a plate is provided in the invention, in which method the plate combined with the substrate can sustain each other, and can counteract the upward stress or downward stress of the radiation-setting resin. Therefore the huge variation of a cover layer thickness of a conventional spin coating method is minimized, and the bending of a cover layer due to a hardening process of radiation-setting resin by a UV light is also minimized.

Moreover, the material of the plate used in the invention includes, but not limited to, glass material or a conventional injection molding disc substrate.

Moreover, the plate method provides a plate to control the thickness of a radiation-setting resin layer, which method is easy to control the uniformity of the thickness of the layer. And because the plate method is simple, therefore it is possible implement the method using an automatic equipment for mass production. Thus, the yield and the through-put can be substantially promoted.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a sectional view illustrating the structure of a reading operation of a disc of a digital video recording system (DVR system).

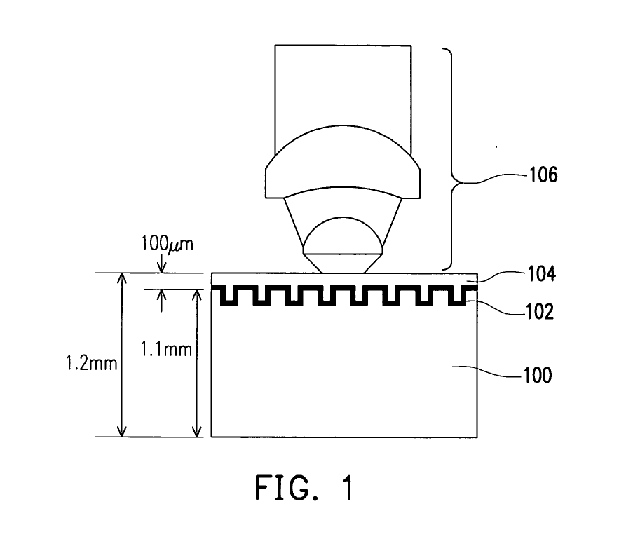

FIG. 2A to FIG. 2D illustrate the manufacturing steps of cover layer of optical information storage media according to the first embodiment of the present invention.

FIG. 3A to FIG. 3D illustrate the manufacturing steps of cover layer of optical information storage media according to the second embodiment of the present invention.

FIG. 4A to FIG. 4D illustrate the manufacturing steps of cover layer of optical information storage media according to the third embodiment of the present invention.

FIG. 5A to FIG. 5D illustrate the manufacturing steps of cover layer of optical information storage media according to the fourth embodiment of the present invention.

FIG. 6A to FIG. 6D illustrate the manufacturing steps of cover layer of optical information storage media according to the fifth embodiment of the present invention.

FIG. 7 is a sectional view illustrating the automatic film stripping device used in the present invention.

### DESCRIPTION OF THE PREFERRED EMBODIMENTS

The manufacturing method of a cover layer of an optical information storage media of the present invention includes using a plate with a plain surface, in which the plate has a poor adhesion, or has no adhesion to a general organic resin material including, but not limited to, acrylic resin, epoxy resin or polyester.

The present invention provides a method of forming a cover of an optical information storage media. A substrate having a digital signal structure or recording layer(s) is provided, wherein the substrate is provided for manufacturing a high density blue laser information storage media. The substrate includes, but not limited to, a disc having a read-only structure, a disc having a write-once structure or a disc having re-writable structure. The high density blue laser information storage media is referred to as an optical information storage media available for recording and replaying operations using a GaN laser or an UV laser disc system with an object lens of high NA larger than 0.5. The wavelength used in a GaN laser or an UV laser disc system is less than, for example, 460 nm.

Next, a radiation-setting resin is disposed between the plate and the substrate, and a spin method is provided for the controlling of the thickness of the radiation-setting resin. The material of the plate is selected such that the adhesion to the radiation-setting resin is poor. After the radiation-setting resin layer is hardened, the hardened radiation-setting resin layer serves as a cover layer on the substrate and then the plate is separated from the radiation-setting resin layer. Because the radiation-setting resin has a poor adhesion to the plate, and has a better adhesion to the substrate, therefore, the plate can easily separate from the hardened radiation-setting resin layer. The thickness of the cover layer is, for example, in a range of about 60 nm to 150 nm. Moreover, the plate can be reused after the plate is separated from the hardened radiation-setting resin layer.

The material of the plate comprises, but not limited to, a transparent material, for example, polycarbonate, polymethyl methacrylate (“PMMA”) or glass, the material may also include, for example, metal or teflon. If a non-transparent plate is used in the present invention, the UV light which is used to harden the radiation-setting resin is directed along the side of the substrate of the disc.

The following embodiment 1 to embodiment 5 describe the method of manufacturing the cover layer of an optical information storage media of the present invention. In the example 1 to example 5, the same elements are referred by the same reference numbers.

### Embodiment 1

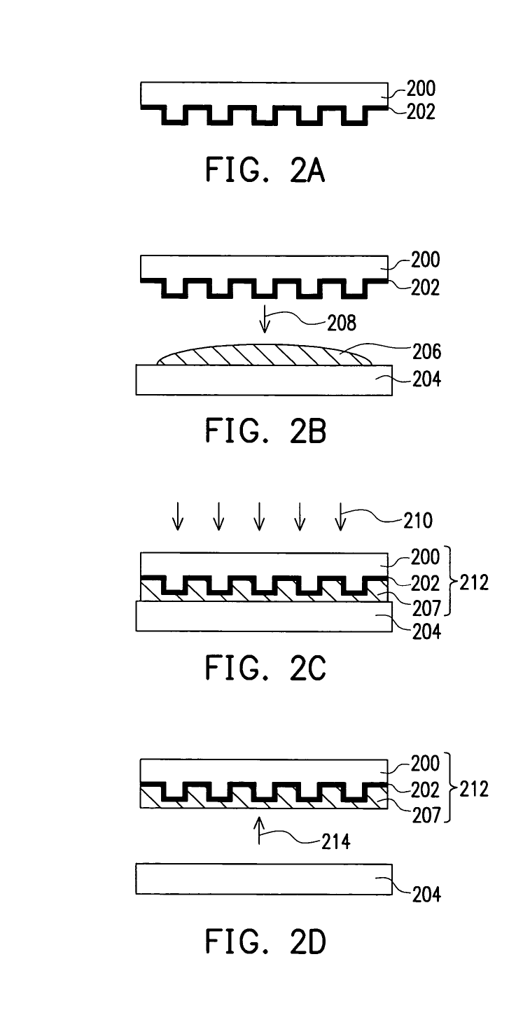

FIG. 2A to FIG. 2D illustrate the manufacturing steps of cover layer of optical information storage media according to the embodiment 1 of the present invention.

Referring to FIG. 2A, a substrate 200 having digital signal structure or recording layer(s) is provided. The material of the substrate 200 includes, but not limited to, polycarbonate. A reflective layer 202 is formed over the substrate 200, a material of the reflective layer includes, but not limited to, gold, silver, aluminum, copper, chromium and alloy thereof. The method of forming the reflective layer includes, for example, a sputtering method.

Referring to FIG. 2B, a plate 204 with a plain smooth surface is provided, wherein the plate 204 has a poor adhesion, or even has no adhesion to a general organic resin material including, but not limited to, acrylic resin, epoxy resin, polycarbonate or polyester. The material of the plate 204 includes, for example but not limited to, plastic, glass or metal. In this embodiment, the plate 204 is composed of, for example, but not limited to, nickel. The plate 204 is placed on a rotatable table (not shown) and a radiation-setting resin is disposed on the plate 204. The material of the radiation-setting resin includes, but not limited to, epoxy resin, acrylic resin or polyester. Then, the substrate 200 is moved along the direction of the arrow 208 and the plate 204 is made to come in contact with the radiation-setting resin 206 and compressing radiation-setting resin 206 against the substrate 200 to form a radiation-setting resin layer 207.

Thereafter, referring to FIG. 2C, after the substrate 200 is adhered to the plate 204, the rotatable table is rotated. The thickness of the radiation-setting resin layer 207 can be controlled by controlling the rotating speed of the rotatable table. Then, the radiation-setting resin layer 207 is hardened by illuminating the radiation-setting resin layer 207 using an UV light 210. Thus the hardened radiation-setting resin layer 207 forms a cover layer of the disc 212.

Finally, referring to FIG. 2D, the disc 212 is separated from the plate 204 by moving the disc 212 along the direction of the arrow 214. The method of separating the disc 212 from the plate 204 includes, but not limited to, a center hole blowing film stripping method. The cover layer of the disc 212 obtained from the embodiment 1 has an average thickness of about 97±3 μm, in which the average thickness refers to a range from an inner diameter 23 mm to an outer diameter 57 mm of the disc.

### Embodiment 2

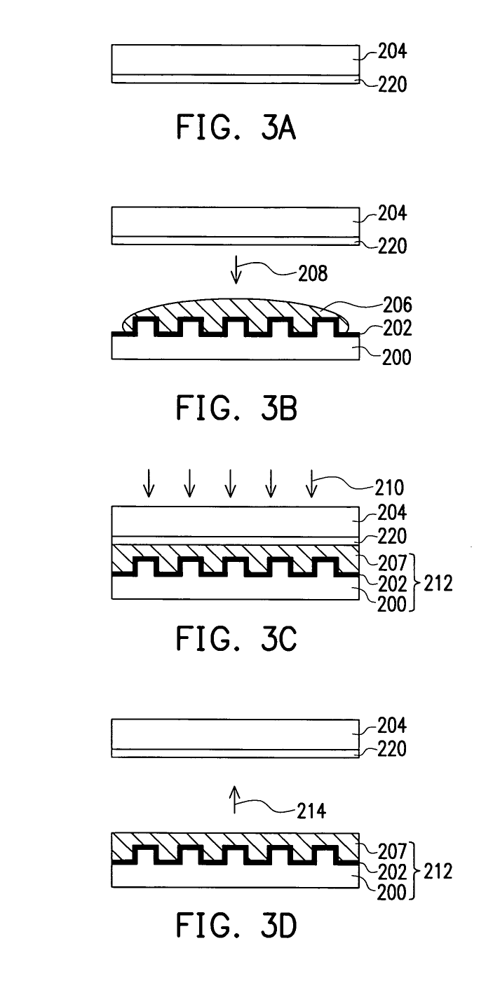

FIG. 3A to FIG. 3D illustrate the manufacturing steps of cover layer of optical information storage media according to the second embodiment of the present invention.

Referring to FIG. 3A, a poorly-adhesive metal layer 220 is formed on a plate 204 having a material composed of, but not limited to, polycarbonate (PC) or polymethyl methacrylate (PMMA). The poorly-adhesive metal layer 220 has a poor adhesion, or has no adhesion to a general organic resin material including, but not limited to, acrylic resin, epoxy resin, polycarbonate or polyester. The material of the poorly-adhesive metal layer includes, but not limited to, gold, silver, aluminum, chromium, platinum, nickel, copper, palladium, silicon and the alloy thereof. The method of forming a poorly-adhesive metal layer includes, for example, but not limited to, a sputtering method, and a thickness of the poorly-adhesive metal layer is, for example, about 20 nm.

Referring to FIG. 3B, a substrate 200 having digital signal structure or recording layer(s) is provided, and the material of the substrate includes, but not limited to, polycarbonate. A reflective layer 202 is disopsed over the substrate 200, the plated substrate 200 is placed on a rotatable table (not shown). Then a radiation-setting resin 206 is disposed on the substrate 200. Then, the plate 204 with the poorly-adhesive metal layer 220 is moved along the direction of the arrow 208 and the poorly-adhesive metal layer 220 is made to come in contact with the radiation-setting resin 206 and compressing radiation-setting resin 206 against the substrate 200 to form a radiation-setting resin layer 207.

Thereafter, referring to FIG. 3C, after the plate 204 with poorly-adhesive metal layer 220 is adhered to the substrate 200, the rotatable table is rotated. The thickness of the radiation-setting resin layer 206 is controlled by controlling the rotating speed of the rotatable table. Then, the radiation-setting resin layer 207 is hardened by illuminating the radiation-setting resin layer 207 using an UV light 210. Thus the hardened radiation-setting resin layer 207 forms a cover layer of the disc 212.

Finally, referring to FIG. 3D, the plate 204 is separated from the disc 212 by moving the plate 204 along the direction of the arrow 214. The method of separating the plate 204 from the disc 212 includes, but not limited to, a center hole blowing film stripping method. The cover layer of the disc 212 obtained from the method of the second embodiment of the present invention has an average thickness of about 101±3 μm, in which the average thickness refers to a range coverage from an inner diameter 23 mm to an outer diameter 57 mm of the disc. Moreover, the poorly-adhesive metal layer 220 is still remain on the plate 204 after the disc 212 is separated from the plate 204, therefore the plate 204 having the poorly-adhesive metal layer 220 can be reused.

### Embodiment 3

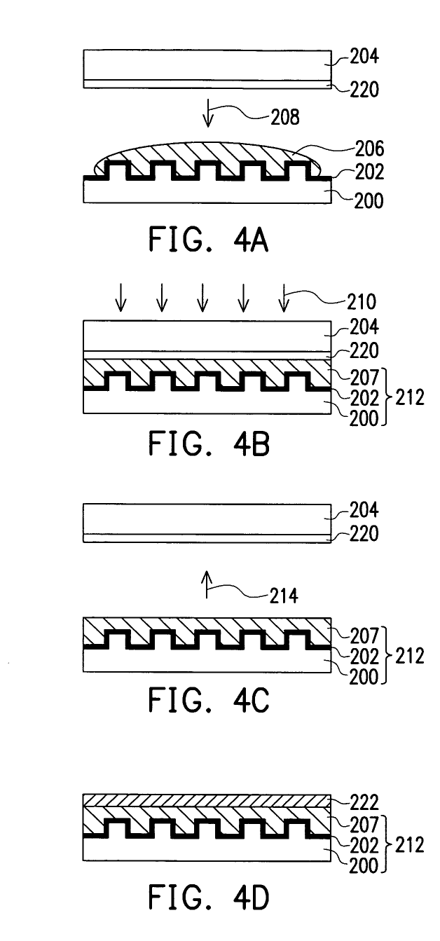

FIG. 4A to FIG. 4D illustrate the manufacturing steps of cover layer of optical information storage media according to the third embodiment of the present invention.

Referring to FIG. 4A, a poorly-adhesive metal layer 220 is formed on a plate 204 composed of, but not limited to, polycarbonate (PC) or polymethyl methacrylate (PMMA). The poorly-adhesive metal layer 220 has a poor adhesion, or has no adhesion to some organic resin includes, but not limited to, acrylic resin, epoxy resin or polyester. The material of the poor adhesion metal layer includes, but not limited to, gold, silver, aluminum, chromium, platinum, nickel, copper, palladium, silicon and the alloy thereof. The method of forming the poorly-adhesive metal layer 220 includes, for example, but not limited to, a sputtering method. A thickness of the poorly-adhesive layer 220 is, for example, about 20 nm.

Next, a substrate 200 having a digital signal structure or recording layer(s) is provided. A reflective layer 202 is disposed over the substrate 200, the substrate 200 is placed on a rotatable table. Then a radiation-setting resin 206 is disposed on the substrate 200. Then, the plate 204 having a poorly-adhesive metal layer 220 is moved along the direction of the arrow 208 and the poorly-adhesive metal layer 220 is made to come in contact with the radiation-setting resin 206 and compressing radiation-setting resin 206 against substrate 200 to form a radiation-setting resin layer 207.

Thereafter, referring to FIG. 4B, after the plate 204 having a poorly-adhesive metal layer is adhered to the substrate 200, the rotatable table is rotated. The thickness of the radiation-setting resin layer 207 is controlled by controlling the rotating speed of the rotatable table. Then, the radiation-setting resin layer 207 is hardened by illuminating the radiation-setting resin layer 207 using an UV light 210. Thus, the hardened radiation-setting resin layer 207 forms a cover layer of the disc 212.

Finally, referring to FIG. 4C, the plate 204 is separated from the disc 212 by moving the plate 204 along the direction of the arrow 214. The method of separating the plate 204 from the disc 212 includes, but not limited to, a center hole blowing film stripping method. The cover layer of the disc 212 obtained from this embodiment has an average thickness of about 49±2 μm, in which the average thickness refers to a coverage range from an inner diameter 23 mm to an outer diameter 57 mm of the disc.

Referring to FIG. 4D, by repeating the manufacturing steps described above, another cover layer 222 is formed on the disc 212 described above. The cover layer 222 of the disc 212 has an average thickness of about 99±3 μm, in which the average thickness refers to a coverage range from an inner diameter 23 mm to an outer diameter 57 mm of the disc. Moreover, the poorly-adhesive metal layer 220 still remain on the plate 204 after the plate 204 is separated from the disc 212, therefore the plate 204 having the poorly-adhesive metal layer 220 can be reused.

### Embodiment 4

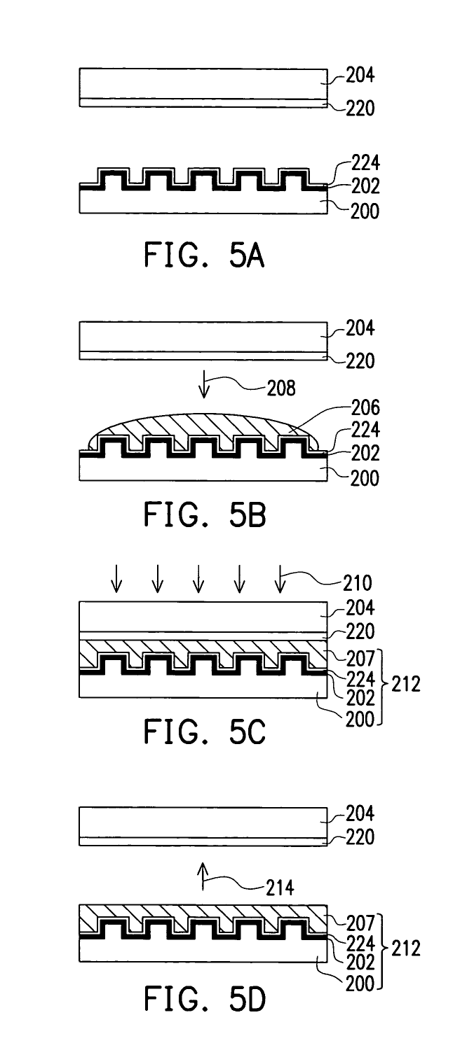

FIG. 5A to FIG. 5D illustrating the manufacturing steps of cover layer of optical information storage media according to the fourth embodiment of the present invention.

Referring to FIG. 5A, a poorly-adhesive metal layer 220 is formed on a plate 204 composed of a material including, but not limited to, polycarbonate (PC) or polymethyl methacrylate (PMMA). The poorly-adhesive metal layer 220 has a poor adhesion, or has no adhesion to some organic resin includes, but not limited to, acrylic resin, epoxy resin or polyester. The material of the poor adhesion metal layer includes, but not limited to, gold, silver, aluminum, chromium, platinum, nickel, copper, palladium, silicon and the alloy thereof. The thickness of the poorly-adhesive metal layer is, for example, about 10 nm to about 60 nm.

A substrate 200 having a digital signal structure or recording layer(s) is provided. A reflective layer 202 is disposed on the substrate 200. Next, the resulting structure is placed on a rotatable table. Next, a poorly-adhesive radiation-setting resin is spin coated on the reflective layer 202, and the thickness of the poorly-adhesive radiation-setting resin layer 206 is controlled in a range of, for example but not limited to, 5 μm. Next, the poorly adhesive radiation-setting resin layer is hardened by illuminating the poorly-adhesive radiation-setting resin layer by using an UV light.

Referring to FIG. 5B, a highly adhesive radiation-setting resin 206 is disposed on the substrate 200. Then, the plate 204 having a poorly-adhesive metal layer 220 is moved along the direction of the arrow 208 and the poorly-adhesive metal layer 220 is made to come in contact with the radiation-setting resin 206 and compressing radiation-setting resin 206 against substrate 200 to form a radiation-setting resin layer 207.

Thereafter, referring to FIG. 5C, the rotatable table is rotated and the thickness of the radiation-setting resin layer 207 is controlled by controlling the rotating speed of the rotatable table. Then, the radiation-setting resin layer 207 is hardened by illuminating the radiation-setting resin layer 207 by using an U light 210. Thus, the hardened radiation-setting resin layer 207 forms a cover layer of the disc 212.

Finally, referring to FIG. 5D, the plate 204 is separated from the disc 212 by moving the plate 204 along the direction of the arrow 214. The method of separating the plate 204 from the disc 212 includes, but not limited to, a center hole blowing film stripping method. The cover layer of the disc 212 obtained from using the method of the embodiment 4 has an average thickness of about 97±3 μm, wherein the average thickness refers to a coverage range from an inner diameter 23 mm to an outer diameter 57 mm of the disc. Moreover, the poorly-adhesive metal layer 220 still remain on the plate 204 after the plate 204 is separated from the disc 212, therefore the plate having the poorly-adhesive metal layer 220 can be reused.

### Embodiment 5

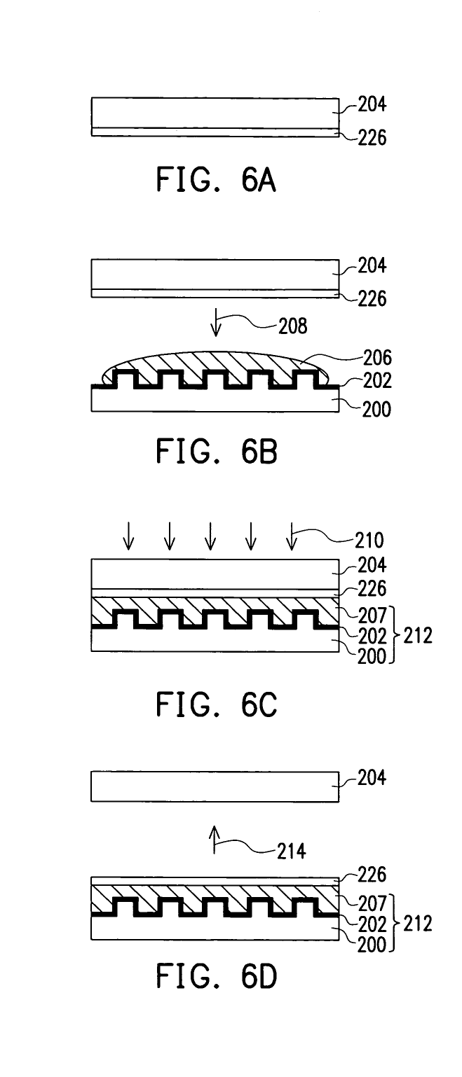

FIG. 6A to FIG. 6D illustrate the manufacturing steps of cover layer of optical information storage media according to the fifth embodiment of the present invention.

Referring to FIG. 6A, a poorly-adhesive organic material layer 226 is formed on a plate 204 composed of a material including, but not limited to, polycarbonate (PC) or polymethyl methacrylate (PMMA). The poorly-adhesive organic material layer 226 has a poor adhesion to a general organic substrate material including, but not limited to, polycarbonate, polymethyl methacrylate (PMMA), or to a metal material. The material of the poorly-adhesive organic material layer includes, but not limited to, epoxy resin, acrylic resin, polyester, nitrocellulose, polyvinyl resin, polymethyl methacrylate (PMMA), fluoropolymers or silicone rubber. The thickness of the poorly-adhesive organic material layer 226 is, for example, in a range of about 1 μm to about 5 μm.

Referring to FIG. 6B, a substrate 200 having a digital signal structure or record layer(s) is provided. A reflective layer 202 is formed on the substrate 200. The resulting structure is placed on a rotatable table (not shown). Next, a highly adhesive radiation-setting resin 206 is disposed the reflective layer 202. Then, the plate 204 having a poorly-adhesive organic material layer 226 is moved along the direction of the arrow 208 and the poorly-adhesive metal layer 220 is made to come in contact with the radiation-setting resin 206 and compressing radiation-setting resin 206 against substrate 200 to form a radiation-setting resin layer 207.

Thereafter, referring to FIG. 6C, after the plate 204 is adhered to the substrate 200, the rotatable table is rotated. The thickness of the radiation-setting resin layer 207 is controlled by controlling the rotating speed of the rotatable table. Then, the radiation-setting resin layer 207 is hardened by illuminating the radiation-setting resin layer 207 by an UV light 210. Thus, the hardened radiation-setting resin layer 207 forms a cover layer of the disc 212.

Finally, referring to FIG. 6D, the plate 204 is separated from the disc 212 by moving the plate 204 along the direction of the arrow 214. The method of separating the plate 204 from the disc 212 includes, but not limited to, a center hole blowing film stripping method. The cover layer of the disc 212 obtained from using the method of the embodiment 5 has an average thickness of about 97±2 μm, wherein the average thickness refers to a coverage range from an inner diameter 23 mm to an outer diameter 57 mm of the disc. Thereafter, the poorly-adhesive organic material layer 226 is provided in order to separate from the plate 204 more easily. Moreover, the poorly-adhesive organic material layer 226 accompanied with the radiation-setting resin layer 206 are separated from the plate 204 after the radiation-setting resin layer 207 is separated from the plate 204.

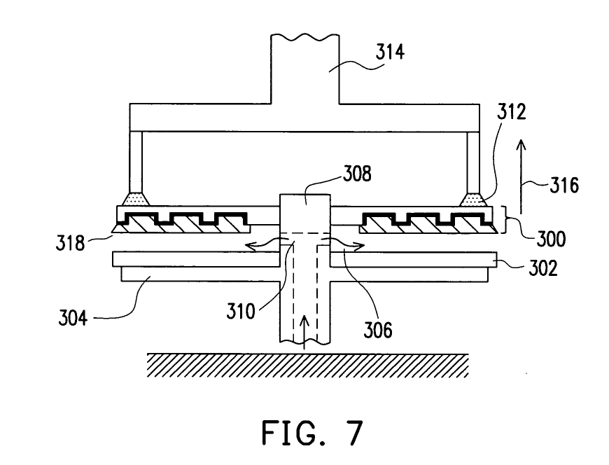

FIG. 7 illustrates the automatic film stripping device used in the present invention. The following is a description of the film stripping process. A structure comprising a disc 300 and a plate 302 is provided. In order to separate the disc 300 from the plate 302, the structure is placed on a vacuum sucking disc base 304 with the central hole of the structure passing through a shaft 308 as shown in FIG. 7. Next, the vacuum sucking disc 330 is allowed to suck the plate 302. The diameter of the plate 302 is a little larger than that of the vacuum sucking disc base 304, and wherein the diameter of the disc 300 is larger than 12 mm. Next, air 306 is blown into the gap between the disc 300 and the plate 302 through a hole 310, which is positioned in the shaft 308. The air 306 is blown from inside of the shaft 308. Next, a vacuum sucking disc 312 of a robotic arm 314 made to come in contact with the disc 300. The vacuum sucking disc 312 of the robotic arm 314 is allowed to suck the disc 300 to hold the disc 300, and the robot arm 314 is made to move along the direction of the arrow 316 to separate the disc 300 from the plate 302. Finally, some redundant residual glue 318 may remain on the edges of the disc 300 can be removed by using a shear or a punch method.

According to the embodiments described above, in general the manufacturing method of a cover layer of an optical information storage media of the present invention comprises, providing a plate having a plain smooth surface and a substrate having a digital signal structure or recording layer(s). Next, a reflective layer is formed on the substrate, a radiation-setting resin is disposed on the reflective layer. Next, the plate is made to come in contact with the radiation-setting resin and compress the radiation-setting resin against the substrate to form a radiation-setting resin layer. Next, the resulting structure is placed on a rotatable table, and then the rotatable table is rotated. The thickness of the radiation-setting resin is controlled by controlling the rotation speed. Next, the radiation-setting resin layer is hardened by illuminating the radiation-setting resin layer using an UV light. After the radiation-setting resin layer is hardened, the plate is separated from the radiation-setting resin layer. Because the radiation-setting resin has a poor adhesion to the plate, and has a better adhesion to the substrate, therefore the radiation-setting resin layer can be easily separated from the plate due to the poor adhesion. The thickness of the cover layer is, for example, in a range of about 60 nm to 150 nm. Moreover, after the plate is separated from the hardened radiation-setting resin, the plate can be reused.

In the description above, the material of the plate is a transparent material, but a non-transparent material may also be used to practice the present invention. If a non-transparent plate is used in the present invention, the UV light used to harden the radiation-setting resin is focussed from the side of the substrate. Moreover, it is to be understood that the thickness of the plate is not a limiting factor. The plate may include a conventional injection molding disc substrate.

Because the method of the present invention, plate and the substrate can support each other, and thus can counteract the upward stress or downward stress of the radiation-setting resin layer. Therefore variation in thickness of the radiation-setting resin layer which would be a case in a conventional spin coating method can be minimized. Further, the bending of the cover layer due to the hardening of the radiation-setting resin by a UV light can also minimized.

Moreover, the method of the present invention provides a plate to not only control the thickness of a radiation-setting resin layer but also forms the radiation-setting resin layer having an excellent thickness uniformity. The method of the present invention is simple, and it can be implemented by using a fully automated equipment for mass production to reduce the overall cost. Thus, the through-put can also be effectively promoted.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A manufacturing method of a cover layer of optical storage media, comprising the following steps:
(a) providing a substrate;
(b) forming a reflective layer on the substrate;
(c) providing a plate having a plain smooth surface;
(d) applying a radiation-setting resin on the reflective layer;
(e) compressing the radiation-setting resin with the plate to form a light-cure resin layer;
(f) rotating the resulting structure to form a radiation-setting resin layer of uniform thickness;
(g) hardening the radiation-setting resin layer to form a hardened radiation-setting resin layer which serves as a cover layer; and
(h) separating the plate from the hardened radiation-setting resin layer, wherein the hardened radiation-setting resin layer remains adhered to the substrate.

2. The manufacturing method of a cover layer of optical storage media of claim 1, wherein a material of the plate comprises plastic, glass or metal.

3. The manufacturing method of a cover layer of optical storage media of claim 1, wherein a material of the radiation-setting resin comprises epoxy, acrylic resin or polyester.

4. The manufacturing method of a cover layer of optical storage media of claim 1, wherein further comprises the repetition from the step (d) to the step (h) after the step (h).

5. The manufacturing method of a cover layer of optical storage media of claim 1, wherein the average thickness of the cover layer is in a range of about 60 nm to about 150 nm.

6. The manufacturing method of a cover layer of optical storage media of claim 1, wherein the method used in the step (h) to separate the plate from the substrate comprises a center hole blowing film stripping method.

7. The manufacturing method of a cover layer of optical storage media of claim 1, wherein further comprises forming a cover layer on the substrate before the step (d).

8. The manufacturing method of a cover layer of optical storage media of claim 1, wherein the substrate is a high density blue laser optical information storage media.

9. The manufacturing method of a cover layer of optical storage media of claim 1, wherein the high density blue laser optical information storage media comprises an optical information storage media, wherein the recording and replaying operations for a gallium nitride (“GaN”) laser or an ultraviolet (“UV”) laser disc system using a high NA larger than 0.5 of an object lens.

10. The manufacturing method of a cover layer of optical storage media of claim 1, wherein the wavelength used by the GaN laser or the UV laser disc system is less than 460 nm.

11. The manufacturing method of a cover layer of optical storage media of claim 1, wherein the substrate is a disc having a recording layer.

12. The manufacturing method of a cover layer of optical storage media of claim 1, wherein the substrate is a disc having a plurality of recording layers.

13. The manufacturing method of a cover layer of optical storage media of claim 1, wherein the substrate is a disc having a digital signal structure.

14. The manufacturing method of a cover layer of optical storage media of claim 1, wherein the substrate is a disc having a read-only structure.

15. The manufacturing method of a cover layer of optical storage media of claim 1, wherein the substrate is a disc having a write-once structure.

16. The manufacturing method of a cover layer of optical storage media of claim 1, wherein the substrate is a disc having a re-writable structure.

17. A manufacturing method of a cover layer of optical storage media, comprising the following steps:
(a) providing a substrate;
(b) forming a reflective layer on the substrate;
(c) providing a plate having a poorly adhesive layer formed thereon;
(d) applying a radiation-setting resin on the reflective layer;
(e) compressing the radiation-setting resin with the plate to form a light-cure resin layer;
(f) rotating the resulting structure to form a radiation-setting resin layer of uniform thickness;
(g) hardening the radiation-setting resin layer to form a hardened radiation-setting resin layer which serves as a cover layer; and
(h) separating the plate from the hardened radiation-setting resin layer, wherein the hardened radiation-setting resin layer remains adhered to the substrate.

18. The manufacturing method of a cover layer of optical storage media of claim 17, wherein the material of the poorly adhesive layer comprises gold, silver, aluminum, chromium, platinum, nickel, copper palladium, silicon and alloy thereof.

19. The manufacturing method of a cover layer of optical storage media of claim 18, wherein the poorly adhesive layer further comprises an organic material.

20. The manufacturing method of a cover layer of optical storage media of claim 19, wherein the organic material comprises epoxy resin, acrylic resin, polyester, nitrocellulose, polyvinyl resin, polymethyl methacrylate (PMMA), fluoropolymers or silicone rubber.
